(19) United States
(12) Patent Application Publication
(10) Pub. No.: US 2009/0070292 A1
(43) Pub. Date: Mar. 12, 2009

(54) Intuitive archiving, retrieving and publishing of data, media and/or information of any format

(75) Inventor: Ronen Sigura, Sunnyvale, CA (US)

Correspondence Address: Ronen Sigura, 1386 Lewiston Drive, Sunnyvale, CA, 94087, US

(73) Assignee: Our Living Journal Partnership Sigura Enterprises, Inc., Sunnyvale, CA (US)

(21) Appl. No.: 11/606,869

(22) Filed: Dec. 1, 2006

(51) Int. Cl. G06F 7/10; G06F 17/30

(52) U.S. Cl. 707/3; 707/100; 707/E17.014

(57) ABSTRACT

To date, it is not possible to intuitively file and retrieve information and/or media in any and all electronic files/format. There is no sufficient intuitive way to archive and retrieve information and/or media in any and all electronic files/format. One needs to create his/her/its own filling system and remember where they might have filed the information. The problem is even more acute when it comes to photos/movies/media, memorabilia and other File formats. In an intuitive way, using everyday concepts such as memory guideline and filling organizers. Using, but not limited to a common denominator such as A house and applying the house logic as the file organizer, one is able to intuitively file and retrieve and type of data/media/file format as the functionality and organization of a house is similar world wide and across cultures. By using the house structure to create the file folders, these folders are by definition intuitive to any person world wide that has basic computer skills but not limited to computer skills.

### FIELD OF THE INVENTION

The present invention relates to filling and retrieving of Electronic files/data/media in general, and more particularly to files/data/media with sentimental value.

### BACKGROUND OF THE INVENTION

To date, it is not possible to intuitively file and retrieve information and/or media in any and all electronic files/format. There is no sufficient intuitive way to archive and retrieve information and/or media in any and all electronic files/format. One needs to create his/her/its own filling system and remember where they might have filed the information. The problem is even more acute when it comes to photos/movies/media, memorabilia and other File formats. This invention relates in general to the ability to file and retrieve any and all data, media and/or other information/electronic files in an intuitive way, using everyday concepts such as memory guideline and filling organizers. Using, but not limited to a common denominator such as A house and applying the house logic as the file organizer, one is able to intuitively file and retrieve and type of data/media/file format as the functionality and organization of a house is similar world wide and across cultures. By using the house structure to create the file folders, these folders are by definition intuitive to any person world wide that has basic computer skills but not limited to computer skills.

### BRIEF DESCRIPTION OF THE DRAWINGS

To provide a more complete understanding of the invention, features uniqueness and advantages, the following is a brief description of all drawings:

FIG. 1 features the “Our Living Journal” home page screen
In FIG. 1 above, one can open edit, add and delete family and personal accounts. Each Personal Account shows but not limited to a personal picture, name and gender. To access account, select window/location of desired account and click image to enter

FIG. 2 features the ability to add any user one desire in any order

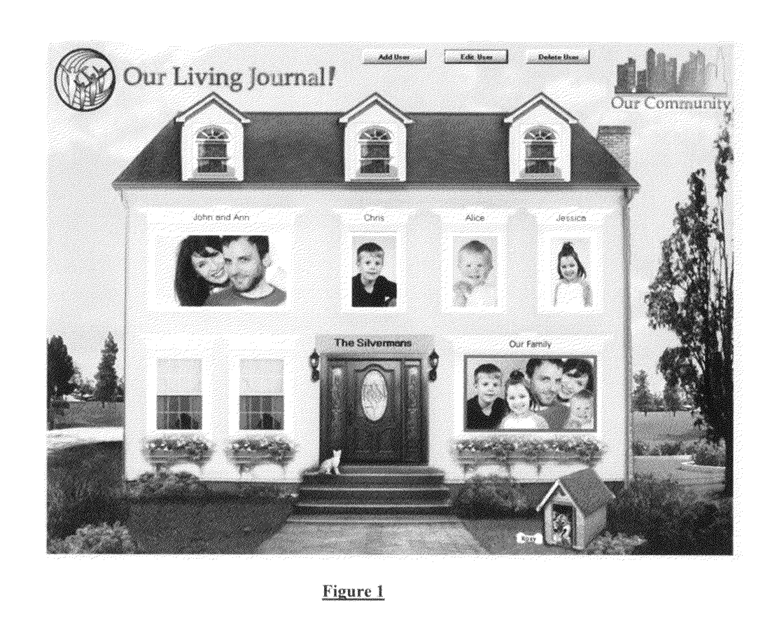

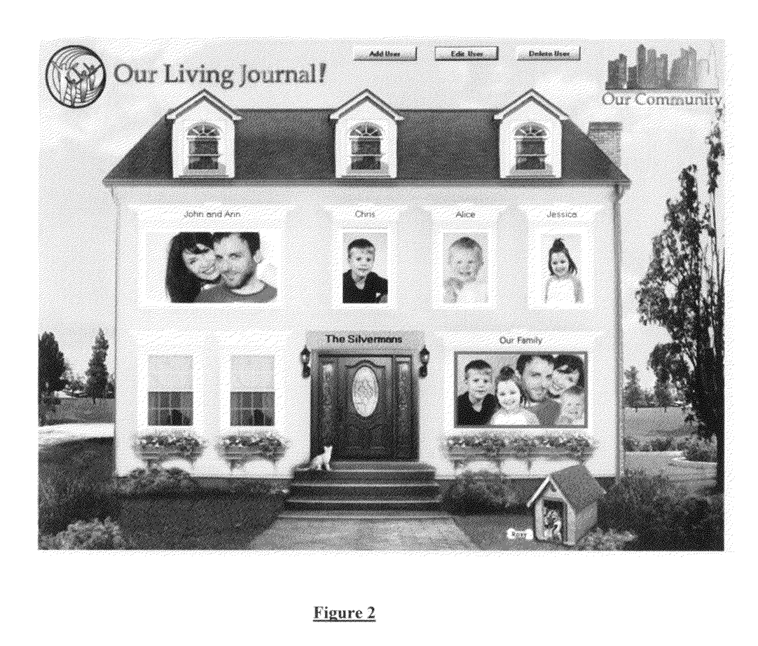

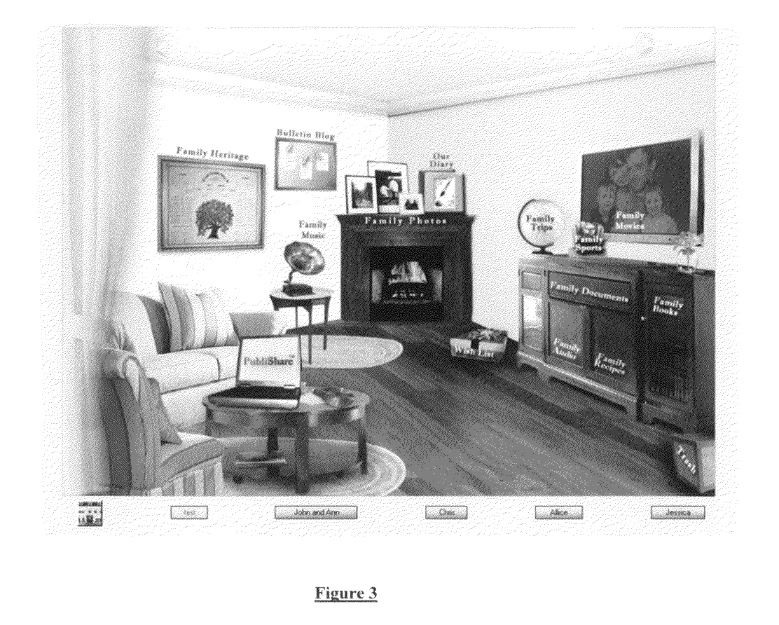

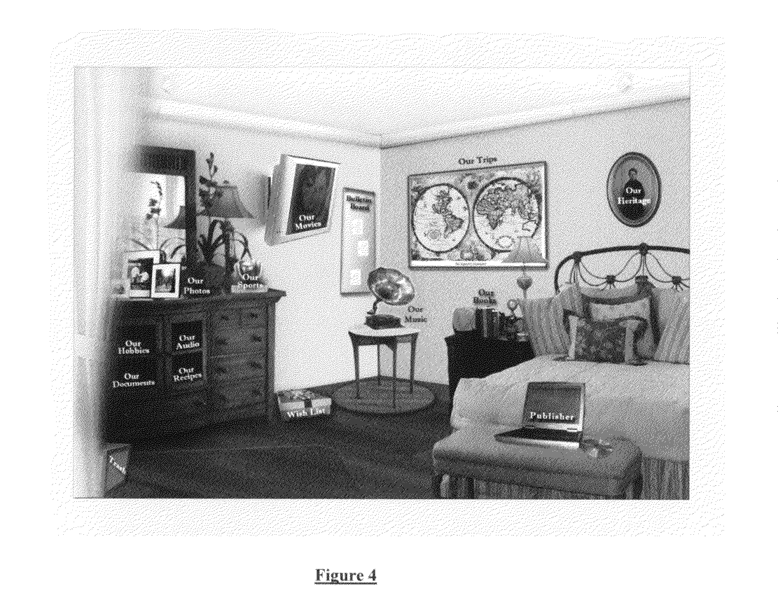

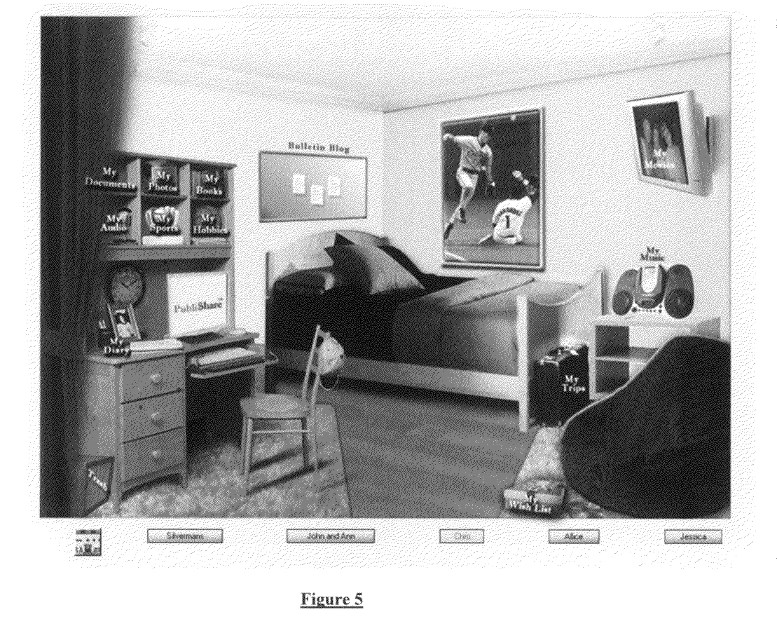

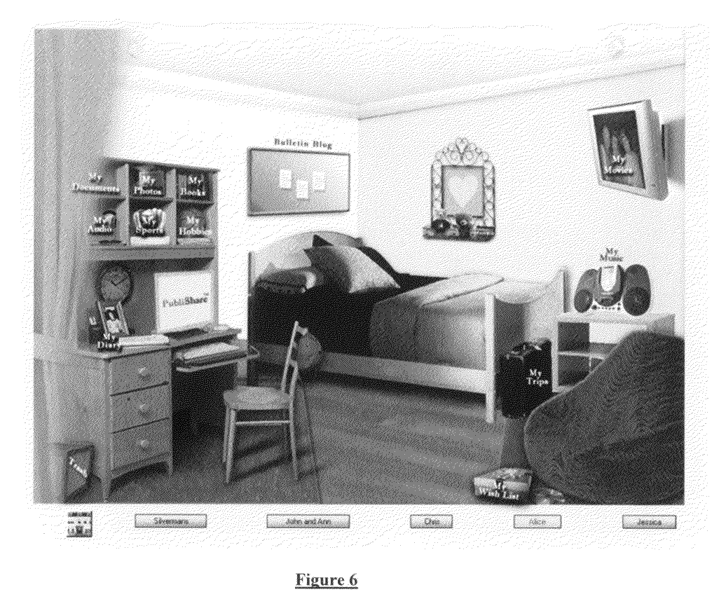

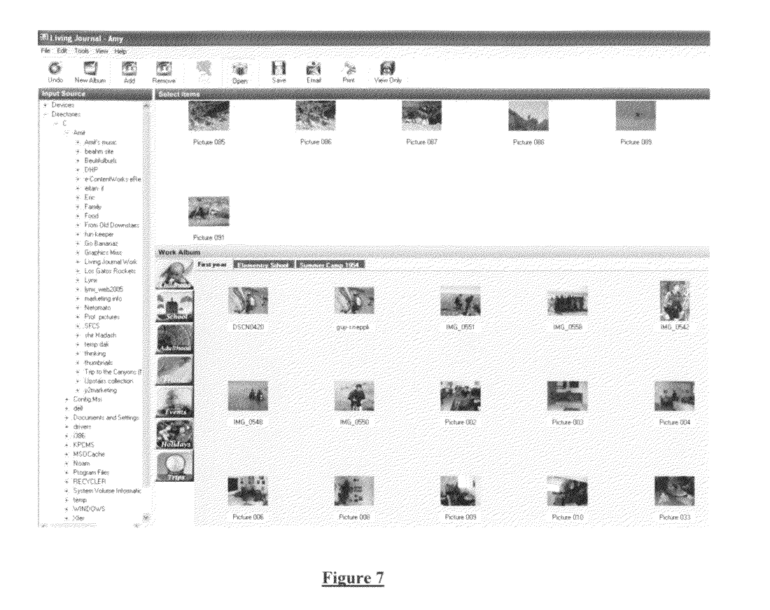

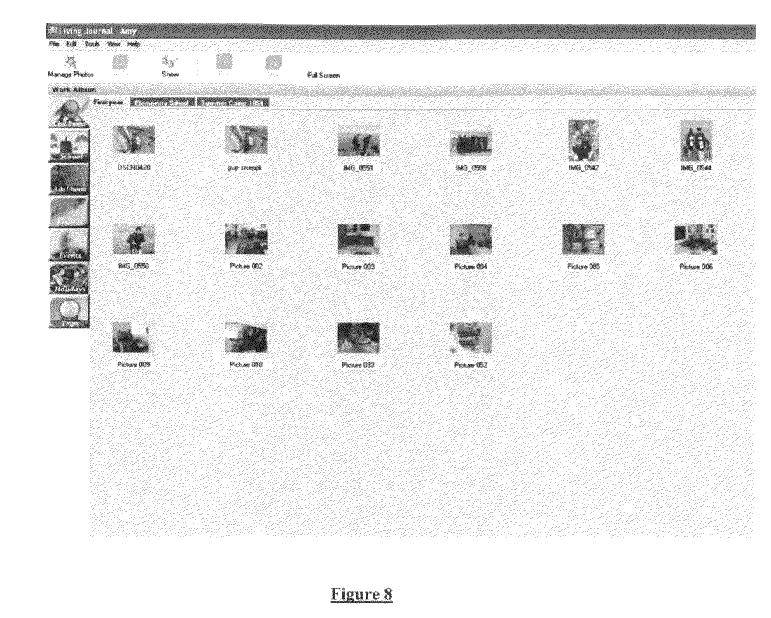

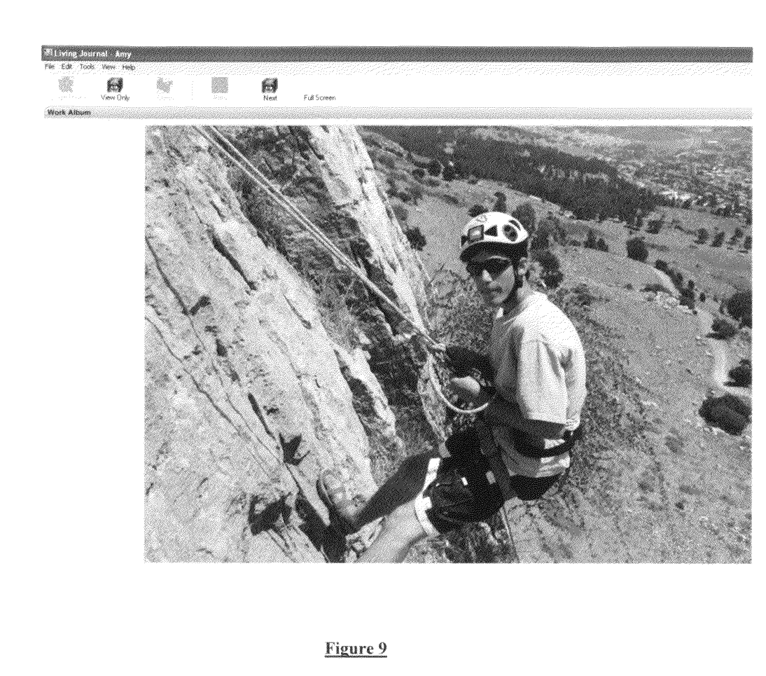

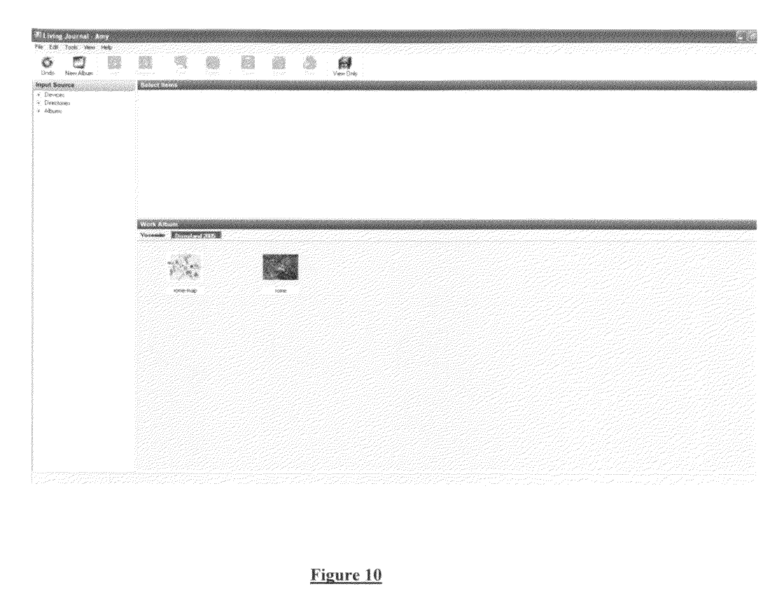

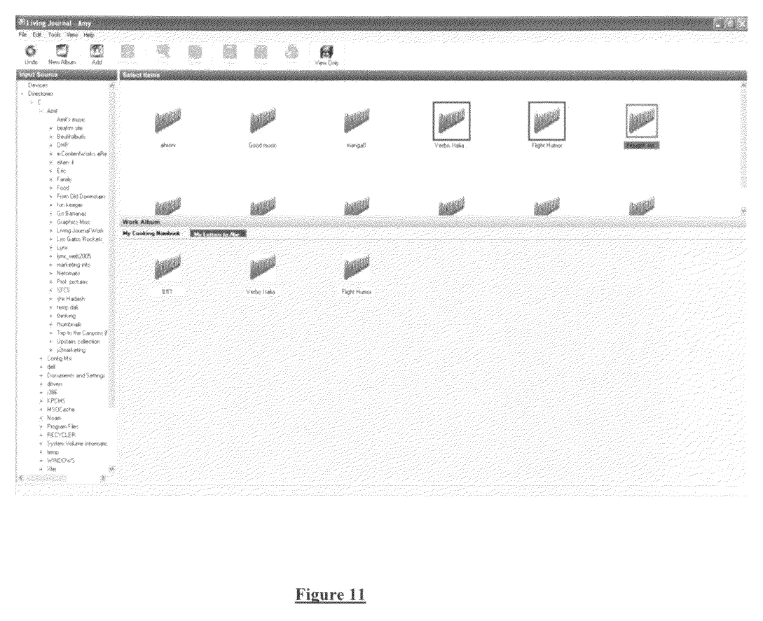

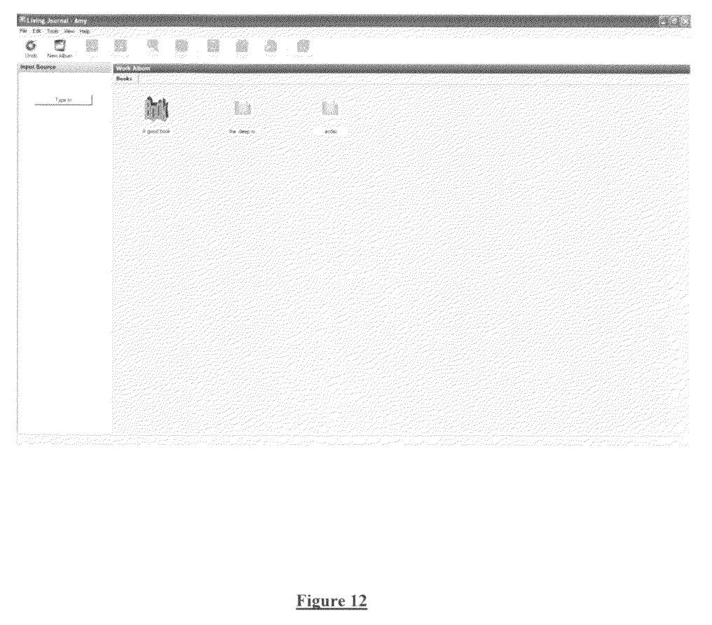

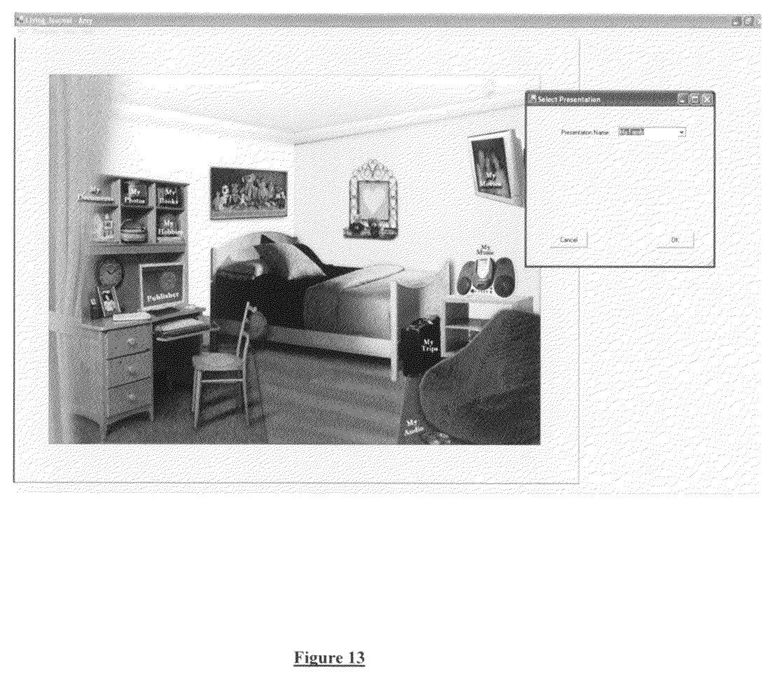

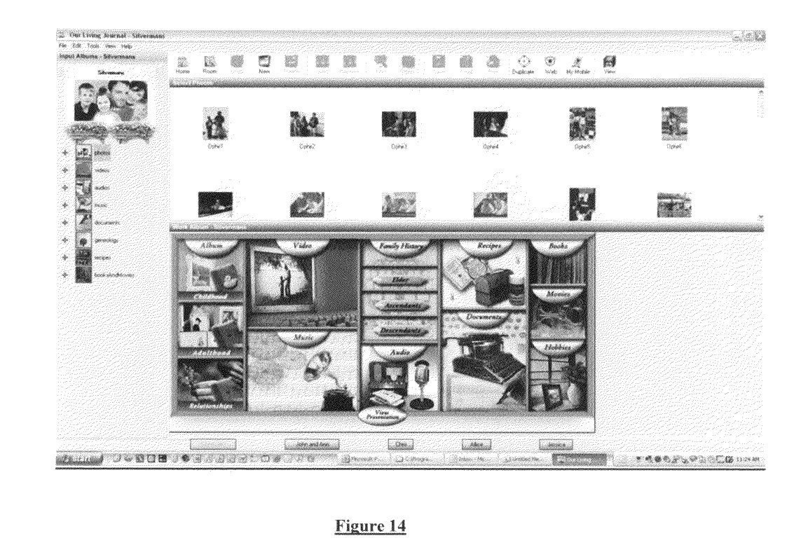

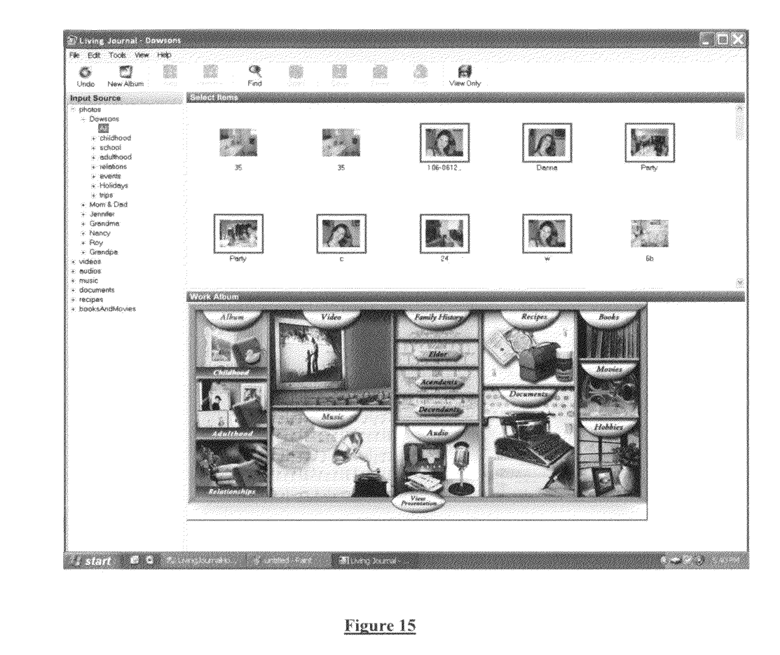

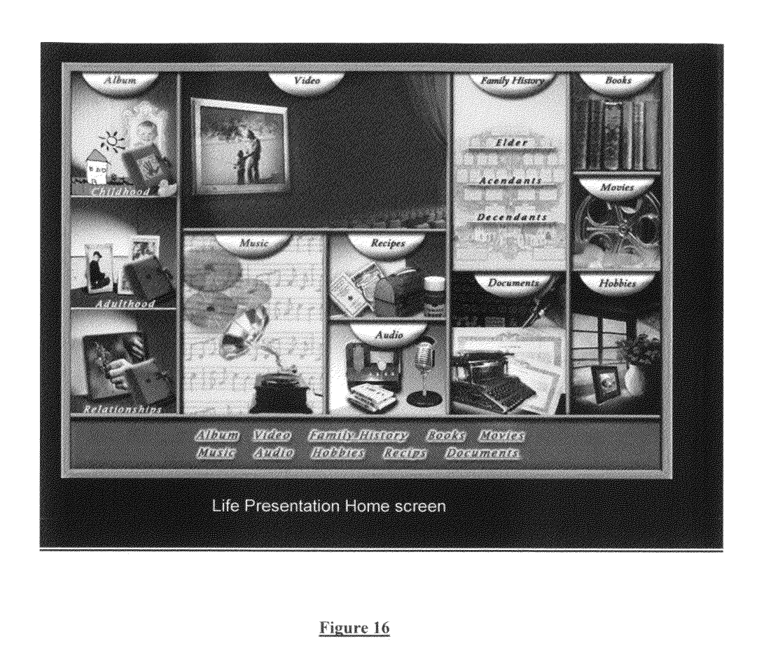

FIG. 3 features the Family Room
In FIG. 3 above, one sees the family room which enables access to editing, filling and retrieving or viewing of the family Photographs, Movies, favorite Books and Movie Collections, Family history, Family recipes, Family documents, Family trips, Family audio recordings and access the living journal publisher, where one can create and publish hard copy and/or other digital interactive presentations

FIG. 4 features the Parents Room
In FIG. 4 above, one sees the Parents room which enables access to editing, filling and retrieving or viewing of the parents Photographs, Movies favorite Books and Movie Collections, Family history, Family recipes, couple documents, couple trips, couple audio recordings and access the living journal publisher, where one can create and publish hard copy and/or other digital interactive presentations

FIG. 5 features the Boy's Room
In FIG. 5 above, one sees the Boy's room which enables access to editing, filling and retrieving or viewing of the of personal Photographs, Movies, favorite Books and Movie Collections, Family history, Personal recipes, personal documents, personal trips, personal audio recordings and access the living journal publisher, where one/the boy can create and publish hard copy and/or other digital interactive presentations

FIG. 6 features the Girl's Room
In FIG. 6 above, one sees the Girl's room which enables access to editing, filling and retrieving or viewing of the of personal Photographs, Movies, favorite Books and Movie Collections, Family history, Personal recipes, personal documents, personal trips, personal audio recordings and access the living journal publisher, where one/the Girl can create and publish hard copy and/or other digital interactive presentations

FIG. 7 features the Our Living Journal Organizer
In FIG. 7 above, one sees the Our Living Journal Organizer which enables the user to file and retrieve photographs in Our Living Journal's pre-defined organizing system Locate files and folders in your computer view them in an explorer like GUI. Open and edit new albums in the predefined categories, drag and drop from a thumbnail view window to add new photographs into albums, add a caption to each Photograph, Email, print or Delete a Photograph from an album. Optional View only mode.

FIG. 8 features the Our Living Journal View Only Mode

FIG. 9 features the Our Living Journal Full Screen View

FIG. 10 features the Our Living Journal Trip Filling

FIG. 11 features the Our Living Journal File & Retrieve methodology
In FIG. 11 above, one can Locate files and folders in your computer view them in an explorer like GUI, open and edit new albums in documents category, drag and drop from a thumbnail, view window to add new item into albums, add a caption to each item, Email, Print, Delete and Open files Optional view mode.

FIG. 12 features Favorite books: add new listings and descriptions

FIG. 13 features accessing publisher/presentation creator from Girl's room

FIG. 14 features the editing screen of the publisher/presentation creator

FIG. 15 features inserting pictures into the publisher/presentation creator

FIG. 16 features the publisher presentation home screen

### IMPORTANT

### Unique & Not Obvious

1. This invention enables any person (who has permission to access the files) to intuitively retrieve any type of data in minimum time without any prior knowledge of/or knowing the person who owns and/or filled the data.
2. This invention enables any person (who has permission to access the files) to intuitively file any type of data in minimum time without any prior knowledge of/or knowing the person who owns and/or previously filled the data.
3. This invention enables any person (who has permission to access the files) to intuitively and in a timely manner, file and retrieve any type of data in minimum time for the purpose of publishing/using the said data without any prior knowledge of/or knowing the person who owns and/or previously filled the data.

What is claimed is:

1. The ability to intuitively file any type of data/media in minimum time without any prior knowledge of/or knowing the person who owns and/or previously filled the data.

2. The ability to intuitively search/retrieve any type of data/media in minimum time without any prior knowledge of/or knowing the person who owns and/or filled the data/media

3. The ability to intuitively, search, file, retrieve and share any type of data/media in minimum time for the purpose of publishing/using the said data without any prior knowledge of/or knowing the person who owns and/or previously filled the data
